(19) United States
(12) Patent Application Publication
(10) Pub. No.: US 2011/0273451 A1
(43) Pub. Date: Nov. 10, 2011

(54) COMPUTER SIMULATION OF VISUAL IMAGES USING 2D SPHERICAL IMAGES EXTRACTED FROM 3D DATA

(76) Inventor: Leo J. Salemann, Sammamish, WA (US)

(21) Appl. No.: 12/776,761

(22) Filed: May 10, 2010

(51) Int. Cl. G06T 15/20

(52) U.S. Cl. 345/427

(57) ABSTRACT

A system, method, and computer-readable instructions for virtual real-time computer simulation of visual images of perspective scenes. A plurality of 2D spherical images are saved as a data set including 3D positional information of the 2D spherical images corresponding to a series of locations in a 3D terrain, wherein each 2D spherical image comprises a defined volume and has an adjacency relation with adjacent 2D spherical images in 3D Euclidean space. As the input for a current virtual position changes based on simulated movement of the observer in the 3D terrain, a processor updates the current 2D spherical image to an adjacent 2D spherical image as the current virtual position crosses into the adjacent 2D spherical image.

### TECHNICAL FIELD

This invention relates to virtual simulation and specifically to an improved system, method, and computer-readable instructions for virtual real-time computer simulation of visual images of perspective scenes.

### BACKGROUND ART

Virtual simulation is widely used for training and entertainment. Virtual simulators present scenes to users in a realistic manner in order to immerse the user into the scene by using a variety of 3D image processing and rendering techniques. The user can, for example, experience flying an airplane or traversing a terrain. A typical virtual simulator combines an image generator, such as a computer, with a display device, such as a display screen or screens. The image generator converts stored 3D data into a 2D scene for display. The generation is considered “real-time” if the images are updated and presented to the user fast enough to provide the user with a sense of moving through the scene.

Unfortunately, real-time generation of visual scenes from 3D data requires substantial manipulation of data, requiring expensive high speed processors, huge data bases, large amounts of computer memory, and the like.

A number of patents exist which relate to virtual simulation, including, U.S. Pat. Nos. 6,020,893, 6,084,979, 7,088,363, 7,492,934; all of which are incorporated herein by reference. However, these patents fail to adequately address real-time virtual simulation in a cost effective manner.

The present invention is designed to address these needs.

### SUMMARY OF THE INVENTION

Broadly speaking, an improved system, method, and computer-readable instructions for virtual real-time computer simulation of visual images of perspective scenes.

The invention can be implemented in numerous ways, including as a system, a device/apparatus, a method, or a computer readable medium. Several embodiments of the invention are discussed below.

In an embodiment, the invention provides a method wherein 3D image data is extracted from a 3D terrain and object database using a virtual camera having a full spherical view within the 3D terrain to create full spherical images in 2D (a panoramic type image). A plurality of full spherical images representing a series of locations/positions in the 3D terrain is then saved as a data set, mapped, for example, as a 3D array/lattice having 3D position information of the spherical images with respect to each other (e.g., set of coordinates in Cartesian space indicating the position of the spherical image data in the 3D terrain wherein a node internal to a 3D array has six neighbors). For example, the data set may comprise a series of full spherical images of the 3D terrain taken every 10 meters throughout the 3D terrain.

A simulated visual image may then be rendered to a user from a point of view (POV) that is the center of the sphere looking outward so that the user can interactively view a portion of the scene within a specified field of view (FOV) of the rendered spherical image.

As the user traverses the “rendered” terrain within a certain spherical image, the user's view of a portion of the spherical image will switch to a view of a portion of the next spherical image as the user crosses into the relative location of the next spherical image in the 3D array/lattice. Switching spherical images may be accomplished using a variety of zoom and blending techniques to provide for a smooth visual transition.

In another embodiment, the invention provides a system comprising a database of spherical images representing a 3D terrain having positional information, a processor and display for rendering the spherical images as a simulated visual image to a user from a point of view (POV) that is the center of the sphere looking outward so that the user can interactively view a portion of the scene within a specified field of view (FOV) of the rendered spherical image. The system also provides input devices for the user to virtually traverse the 3D terrain wherein the processor renders images to the user representing the user's virtual location in the 3D terrain.

A computer program product is also provided that comprises a computer usable medium having a computer readable program code embodied therein, adapted to be executed by a processor to implement the methods of the invention. The invention may include a number of software components, such as a logic processing module, configuration file processing module, data organization module, and data display organization module, that are embodied upon a computer readable medium.

The advantages of the invention are numerous. One significant advantage of the invention is that the images may be rendered without being computationally expensive. As a result, the methods of the invention can be implemented on devices having much less computational power and memory than most virtual reality systems using 3D databases.

Other aspects and advantages of the invention will become apparent from the following detailed description taken in conjunction with the accompanying drawings, illustrating, by way of example, the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of a general purpose computer system that is programmed by the techniques of the present invention render real-time visual images of perspective scenes.

FIG. 2 is a diagram showing virtual camera angles.

FIG. 3 is a flowchart representing steps of an embodiment.

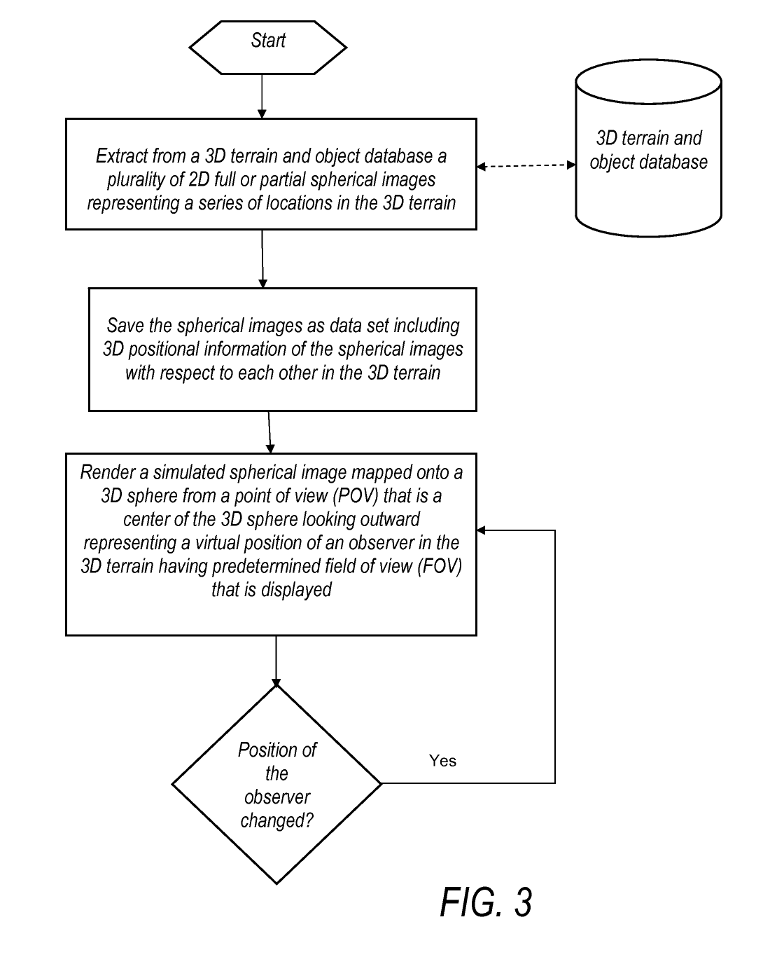

### DETAILED DESCRIPTION OF THE PREFERRED EMBODIMENT

Referring now to the drawings, the preferred embodiment of the present invention will be described.

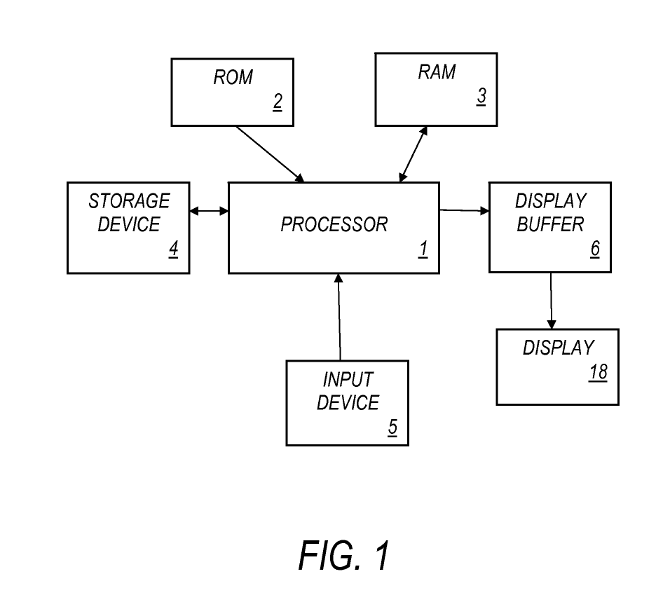

Referring now to FIG. 1, an exemplary computer system on which the software techniques of the present invention runs is described. Generally, the image rendering techniques of the present invention may be implemented by a general purpose computing device/computer programmed to carry out the specific methods set forth herein. Typically, such a general purpose computer comprises a processor 1 which is connected to either or both a read-only-memory 2 and/or a random-access-memory 3. The read-only-memory 2 stores program instructions and data of a permanent nature. The random-access-memory 3 is used to store program instructions and data temporarily in response to commands from the processor 1. For example, the random-access memory 3 may store particular programs or segments of programs used to carry out specific functions, the processor 1 being response to the stored programs to carry out the functions of the programs as if the processor were a hardwired, dedicated device. Additionally, the random-access memory 3 may be used to store current data or intermediate results in a manner well known in the art.

The computer system also has one or more storage devices 4, such as a hard disk drive, CD-ROM, floppy drive or other storage media operably connected to the processor. The storage device 4 may contain programs that are accessed by the processor to program the process to perform specific functions as well as data to be used by programs, such as the present invention.

The processor 1 receives operator input from one or more input devices 5, such as a keyboard, joystick or mouse. Acting on the operator input, the processor 1 performs various operations and writes the output of such operations to the display buffer 6, also called video memory. The contents of the display buffer 6 or video memory are written to the display 18, forming an image on the display 18.

In a further embodiment, another exemplary computer system on which the software techniques of the present invention runs can comprise a portable computing device such as an Apple® iPod™ or the like, having a processor, memory, input and output/display capabilities.

Data for terrain models can come from many sources, including sensors such as LIDAR, satellite imagery, Video, SAR, and the like. A volumetric representation for the terrain can then be developed and stored in a database. One approach for 3D terrain and object databases is implemented using voxels, or volume elements. The 3D voxel model can be created using multiple imagery and data sources. Voxels are especially well suited to show fuzziness or incomplete data as probability displays (e.g., incomplete or semi-transparent voxels).

Generally, to utilize a 3D terrain model database for displaying images, rendering algorithms are required to render the image. The rendered image is a perspective projection of the voxels to the screen along rays from the database to the eyepoint. This is computationally expensive.

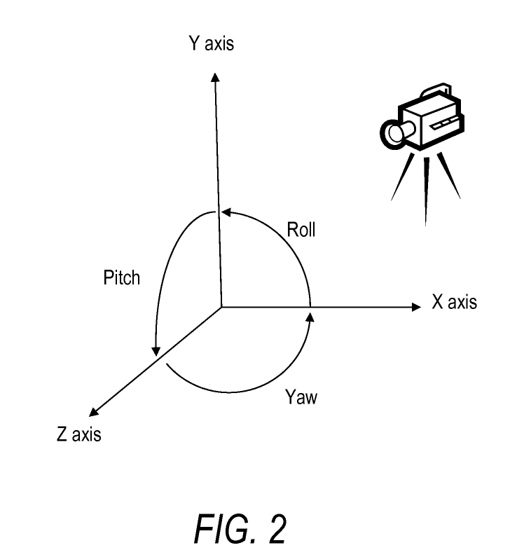

Within a 3D terrain and object databases, a “virtual camera” can be defined specifiable with six degrees of freedom (x, y, z, yaw, pitch, roll), see FIG. 2. 2D images taken by the virtual camera can be exported from the 3D terrain and object database to be stored and/or utilized elsewhere. The virtual camera can be considered to be placed in the location of an observer in the 3D terrain which generally would use a 30° field of view (FOV)/point of View (POV). A POV camera is considered “within a scene”, rather than viewing the scene from a remote location.

However, for a virtual camera, the FOV can be also defined mathematically as a half sphere or full sphere rather than a limited 30° cone, to capture a scene in the 3D terrain in multiple or even all possible viewing directions simultaneously. This would allow the camera to “see” a full spherical view simultaneously from within the 3D terrain and create a full spherical image. Just as there are 360 degrees or 2π radians in a circle, there are 4π steradians in a sphere so this means that everything in all directions is visible: front, back, left, right, up, down. Full sphere images can also be assembled from separate images such as a pair of 180 degree images can be combined into a composite 4π steradian image.

In a simulation of a UAV (unmanned aerial vehicle), wherein only a half sphere camera angle is needed (180 degree FOV camera model looking out from the belly of the aircraft (bottom half of sphere)), an embodiment of the invention may utilize half spherical images in a similar manner as described herein with respect to full spherical images. Similarly, other partial spherical images are contemplated herein depending on the requirements of the simulation.

A plurality of spherical images representing a series of predetermined locations/positions in the 3D terrain is then saved as data set. The plurality of images are preferably mapped, for example, as a 3D array/lattice having 3D position information of the spherical images with respect to each other (e.g., set of coordinates in Cartesian space indicating the position of the spherical image data in the 3D terrain wherein a node internal to a 3D array has six neighbors). For example, the data set may comprise a series of spherical images of the 3D terrain taken every 10 meters throughout the 3D terrain.

The spherical image data may be saved in a variety of formats as known in the art. The spherical image may be saved as a full sphere image in an equidistant cylindrical projection (which is highly distorted but containing the necessary information from which other views can be extracted). Similarly, image can be converted into a scanning panoramic format or central cylindrical projection.

For projecting the image for viewing, the saved spherical image data can be mapped onto a 3D sphere. The texture mapping the 4π steradian image onto the surface of a sphere then allows extracting the desired views (FOV) from the center of the sphere (POV).

Virtual reality systems operate by extracting part of the image corresponding to the observer's current view. Here, a simulated visual image may then be rendered to a user from a point of view (POV) that is the center of the sphere looking outward so that the user can interactively view a portion of the scene within a specified field of view (FOV) of the rendered spherical image.

The field of view may be, for example, a simulated 40 degree FOV camera on a UAV's belly rendered on a flat 2D video display device. For a more immersive experience, various types of HMDs and/or multiple display screens can be utilized.

The user can interact with image(s) using known techniques of traversing virtual 3D space. For example, the user's location within the 3D space and the user's virtual movements through the 3D space would be tracked by the system through input devices such as touch pads, joy sticks, mouse, simulated flight controls, and the like.

As the user moves through the “rendered” 3D terrain within a certain spherical image, the user's view of a portion of the spherical image will switch to a view of a portion of the next spherical image as the user crosses into the relative location of the next spherical image in the 3D array/lattice. Switching spherical images may be accomplished using a variety of zoom and blending techniques to provide for a smooth visual transition.

In an alternate embodiment, the spherical image is applied to 3D polygonal sphere, which could represent the spherical projection screens used in high-fidelity flight simulators. The spherical image is rendered on the polygonal sphere. As the user moves through 3D space, the polygonal sphere is “carried” with him or her, and the current spherical image is either magnified or swapped for the next one in the 3D array/lattice, depending on the user's position.

The following is an example of a UAV simulation in accordance with the present invention. A 3D terrain database is provided, representing for example, a 1 km voxel world. To extract the images, a camera position is selected based on desired output. For example an altitude of 138 m provides 40 degree FOV. The images may be taken along a circular path in the middle of the voxel world, in effect creating a “video-sequence” of spherical images. If the video sequence is played back as an “animated texture” on a 3D polygonal sphere, the user will have the illusion of moving along the circular route. Since the image is spherical, the user will be able to change his or her viewpoint at will. The effect would be similar to riding an amusement park ride, where the route is constrained, but the passengers can look anywhere they wish.

In a further example, the system may be based on panoramic images obtained in a variety of ways. The process of compiling source images into a single panoramic image is commonly referred to as “stitching.” There are many software applications available to stitch panoramas. Stitching generally involves importing source images into the stitching environment, aligning the images relative to one another by either overlapping two or more images or setting common “anchor points” (physical features clearly visible in both images), and then rendering the output. A panorama can be rendered out as several different formats, called projections: cylindrical, equirectangular, also called spherical, cubical (six equirectangular cube faces), and the like. Using available panoramic image stitching software (such as Panoweaver™ from Easypano), both spherical 360 panoramas and cylindrical panoramas from either fisheye photos or normal pictures can be stitched together. Image capture devices, such as cameras, are used to capture an image of a section of a view. Multiple overlapping images of segments of the view are taken and then the images are joined together, or “merged,” to form a composite image, known as a panoramic image. Image stitching software blends the images so to generate a panoramic image.

A panoramic image provides a full 360×180 degree field of view, fully immersing the viewer when wrapped around the eye-point in a sphere. As the user moves, his eye-point from one x,y,z location to another, a new panoramic image is paged in, depicting the view of the world form the new vantage point. The system may provide user cues such as arrows to seamlessly move from one panorama to another. The system supplies a collection of panoramic images, each of which represents a view point at a particular x,y,z, location. Collectively, the image can be thought of as being arranged in a 3D lattice. The 3D lattice provides for left/right, up/down, and forward/backward movement. As the user's eye-point moves from one cell to the next in the lattice, the appropriate image is paged in. Real-time image paging (the ability to refresh the panoramic image at 15-30 Hz) may be provided as well as the ability to run without wireless communication access. Server based solutions may also be provided.

In another example, a textured sphere approach may be used. This approach involves a 3D polygonal sphere which is textured by a sequence of images or video. This approach could use a real-time 3D rendering system, in which a 3D polygonal sphere is textured with a “panoramic video.” The panoramic video is composed of frames, each frame is one panoramic image from one position in the world. Unlike the 3D lattice embodiment, in this approach, the user would track like at an amusement park. Play/rewind would move the user along the track. The user could rotate his eye-point, and move along the track forward/backward at any speed or to stop.

Computer program code for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile/video disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It should be understood that the examples and embodiments described herein are for illustrative purposes only and that various modifications or changes in light thereof will be suggested to persons skilled in the art and are to be included within the spirit and purview of this application.

What is claimed is:

1. A method for virtual real-time computer simulation of visual images of perspective scenes, comprising:
(a) saving a plurality of 2D spherical images as a data set including 3D positional information of the 2D spherical images corresponding to a series of locations in a 3D terrain, wherein each 2D spherical image comprises a defined volume and has an adjacency relation with adjacent 2D spherical images in 3D Euclidean space;
(b) receiving an input for a current virtual position of an observer in the 3D terrain, wherein the virtual position in the 3D terrain is mapped to a corresponding 2D spherical image for that location in 3D Euclidean space, wherein the virtual position places the observer virtually within a current 2D spherical image;
(c) rendering a simulated spherical image for the current 2D spherical image, wherein the simulated spherical image is mapped onto a 3D sphere from a point of view (POV) that is a center of the 3D sphere looking outward;
(d) displaying a portion of the simulated spherical image representing a field of view (FOV) based on an eye-point of the observer; and
(e) as the input for the current virtual position changes based on simulated movement of the observer in the 3D terrain, updating the current 2D spherical image to an adjacent 2D spherical image as the current virtual position crosses into the adjacent 2D spherical image, and repeating steps (c) through (e).

2. The method of claim 1 wherein the spherical images are saved as a data set represented as a lattice structure having three dimensions.

3. The method of claim 2 wherein the lattice comprises a 3D array wherein each spherical image comprises a position identifier representing its x, y, z position in the 3D array.

4. The method of claim 1 wherein simulated movement of the virtual position of the observer within a boundary of the 3D sphere is displayed in the field of view (FOV) using image zooming techniques as the eye-point approaches the boundary.

5. The method of claim 1 wherein simulated movement of the virtual position of the observer across a boundary of the 3D sphere into an adjacent 3D sphere is rendered using image blending techniques as the eye-point passes the boundary.

6. The method of claim 1 wherein simulated movement comprises left, right, up, down, forward, and backward directional movement based on input received.

7. The method of claim 1 wherein the field of view (FOV) of the observer is updated based on input received.

8. The method of claim 1 wherein the plurality of two-dimensional (2D) spherical images are extracted from a three-dimensional (3D) terrain and object database, wherein the extracted 2D spherical images correspond to the series of locations in the 3D terrain, and wherein the series of locations are defined in 3D Euclidean space by Cartesian coordinates.

9. The method of claim 8 wherein the extracted 2D spherical images are extracted using a virtual camera having a defined spherical view within the 3D terrain to directly capture the extracted 2D spherical images.

10. The method of claim 8 wherein the extracted 2D spherical images are extracted using a virtual camera having a non-spherical field of view within the 3D terrain by capturing multiple images at each of the series of locations in the 3D terrain and stitching the multiple images into a panoramic image resulting in the extracted 2D spherical image.

11. A virtual reality system for virtual real-time computer simulation of visual images of perspective scenes, comprising:
a storage device of the virtual reality system having stored therein a plurality of 2D spherical images as a data set including 3D positional information of the 2D spherical images corresponding to a series of locations in a 3D terrain, wherein each 2D spherical image comprises a defined volume and has an adjacency relation with adjacent 2D spherical images in 3D Euclidean space;
a processor of the virtual reality system for receiving an input from an input device for a current virtual position of an observer in the 3D terrain, wherein the virtual position in the 3D terrain is mapped to a corresponding 2D spherical image for that location in 3D Euclidean space, wherein the virtual position places the observer virtually within a current 2D spherical image;
wherein the processor renders a simulated spherical image for the current 2D spherical image, wherein the simulated spherical image is mapped onto a 3D sphere from a point of view (POV) that is a center of the 3D sphere looking outward;
a display device of the virtual reality system for displaying a portion of the simulated spherical image representing a field of view (FOV) based on an eye-point of the observer;
wherein as the input for the current virtual position changes based on simulated movement of the observer in the 3D terrain, the processor updates the current 2D spherical image to an adjacent 2D spherical image as the current virtual position crosses into the adjacent 2D spherical image.

12. The virtual reality system of claim 11 wherein the spherical images are saved as a data set represented as a lattice structure having three dimensions.

13. The virtual reality system of claim 12 wherein the lattice comprises a 3D array wherein each spherical image comprises a position identifier representing its x, y, z position in the 3D array.

14. The virtual reality system of claim 11 wherein simulated movement of the virtual position of the observer within a boundary of the 3D sphere is displayed in the field of view (FOV) using image zooming techniques as the eye-point approaches the boundary.

15. The virtual reality system of claim 11 wherein simulated movement of the virtual position of the observer across a boundary of the 3D sphere into an adjacent 3D sphere is rendered using image blending techniques as the eye-point passes the boundary.

16. The virtual reality system of claim 11 wherein simulated movement comprises left, right, up, down, forward, and backward directional movement based on input received.

17. The virtual reality system of claim 11 wherein the field of view (FOV) of the observer is updated based on input received.

18. The virtual reality system of claim 11 wherein the plurality of two-dimensional (2D) spherical images are extracted from a three-dimensional (3D) terrain and object database, wherein the extracted 2D spherical images correspond to the series of locations in the 3D terrain, and wherein the series of locations are defined in 3D Euclidean space by Cartesian coordinates.

19. The virtual reality system of claim 18 wherein the extracted 2D spherical images are extracted using a virtual camera having a defined spherical view within the 3D terrain to directly capture the extracted 2D spherical images.

20. The virtual reality system of claim 18 wherein the extracted 2D spherical images are extracted using a virtual camera having a non-spherical field of view within the 3D terrain by capturing multiple images at each of the series of locations in the 3D terrain and stitching the multiple images into a panoramic image resulting in the extracted 2D spherical image.

21. A computer program product comprising a computer usable medium having a computer readable program code embodied therein, adapted to be executed by a processor to implement the method of claim 1.
